(19) United States
(12) Patent Application Publication
(10) Pub. No.: US 2025/0282078 A1
(43) Pub. Date: Sep. 11, 2025

(54) SAW CHAIN

(71) Applicant: MAKITA CORPORATION, Anjo-shi (JP)

(72) Inventors: Tomoyuki KUTSUNA, Anjo-shi (JP); Kyohei SHINO, Anjo-shi (JP)

(73) Assignee: MAKITA CORPORATION, Anjo-shi (JP)

(21) Appl. No.: 19/062,275

(22) Filed: Feb. 25, 2025

(30) Foreign Application Priority Data
Mar. 11, 2024 (JP) 2024-036927

(51) Int. Cl. B27B 33/14; B27B 17/00; B27B 17/02

(52) U.S. Cl. CPC B27B 33/141; B27B 17/0008; B27B 17/02

(57) ABSTRACT

A saw chain disclosed herein may be configured to be movably mounted along a periphery of a guide bar. The saw chain may include a plurality of drive links, a plurality of side links, and a plurality of connection pins. At least two side links of the plurality of side links may each include a cutting portion including a cutting blade and a depth gauge. A kerf width of the saw chain may be in a range of 4.3 mm to 4.6 mm. A depth of the saw chain may be in a range of 0.1 mm to 0.3 mm. A chain pitch of the saw chain may be in a range of 8.0 mm to 8.5 mm.

### REFERENCE TO RELATED APPLICATION

This application claims priority to Japanese Patent Application No. 2024-036927 filed on Mar. 11, 2024. The entire content of the priority application is incorporated herein by reference.

### TECHNICAL FIELD

The art disclosed herein relates to saw chains.

### BACKGROUND ART

US Patent Application Publication No. 2011/0179652 describes a saw chain configured to be movably mounted along a periphery of a guide bar. Thie saw chain includes a plurality of drive links each comprising two drive link through holes and arranged along a chain movement direction in which the saw chain moves with respect to the guide bar; a plurality of side links each comprising two side link through holes and located on both left side and right side of the plurality of drive links in a left-right direction orthogonal to the guide bar; and a plurality of connection pins connecting the drive links and the side links to each other by being inserted through the drive link through holes and the side link through holes. At least two side links of the plurality of side links each comprise a cutting portion including a cutting blade and a depth gauge. In the left-right direction, a distance between a left end of the cutting blade of a side link of the at least two side links located on the left side of the plurality of drive links and a right end of the cutting blade of a side link of the at least two side links located on the right side of the plurality of drive links is in a range of 4.3 mm to 4.6 mm. In a chain height direction orthogonal to the left-right direction and the chain movement direction, a distance between a top of the cutting blade of the side link and a top of the depth gauge of the side link is in a range of 0.1 mm to 0.3 mm.

### SUMMARY

For example, when a saw chain cuts an object that is not securely held in place (e.g., a twig), the object may shake against the saw chain. In another example, when a saw chain cuts a bulky object (e.g., a thick branch), chips may accumulate between the saw chain and the object. The disclosure herein provides a technology that can suppress chips from accumulating between a saw chain and an object to be cut during cutting work, while suppressing the object from shaking against the saw chain.

A saw chain disclosed herein may be configured to be movably mounted along a periphery of a guide bar. The saw chain may comprise a plurality of drive links each comprising two drive link through holes, wherein the drive links are arranged along a chain movement direction in which the saw chain moves with respect to the guide bar, a plurality of side links each comprising two side link through holes, wherein the side links are located on both left side and right side of the plurality of drive links in a left-right direction orthogonal to the guide bar, and a plurality of connection pins, wherein the connection pins connect the drive links and the side links to each other by being inserted through the drive link through holes and the side link through holes. At least two side links of the plurality of side links may each comprise a cutting portion including a cutting blade and a depth gauge. In the left-right direction, a distance between a left end of the cutting blade of a side link of the at least two side links located on the left side of the plurality of drive links and a right end of the cutting blade of a side link of the at least two side links located on the right side of the plurality of drive links (this distance may be referred to as “kerf width” herein) may be in a range of 4.3 mm to 4.6 mm. In a chain height direction orthogonal to the left-right direction and the chain movement direction, a distance between a top of the cutting blade of the side link and a top of the depth gauge of the side link (this distance may be referred to as “depth” herein) may be in a range of 0.1 mm to 0.3 mm. An average of a distance between center axes of the two drive link through holes of each drive link and a distance between center axes of the two side link through holes of each side link (this average may be referred to as “chain pitch” herein) may be in a range of 8.0 mm to 8.5 mm.

In the configuration above, the kerf width and depth are both small, allowing for a reduction in the size of the cutting portions. This suppresses an object to be cut from shaking against the saw chain during cutting work. Further, in the configuration above, the kerf width and depth are both small, and thus an amount of cutting by each cutting portion (i.e., an amount of chips generated by each cutting portion) is reduced. This suppresses accumulation of chips between the saw chain and an object to be cut during cutting work. Moreover, in the configuration above, the chain pitch is larger than, for example, the chain pitch (approximately 6.4 mm) of a saw chain described in US Patent Application Publication No. 2011/0179652. This means that the intervals between the side links in the chain movement direction are relatively large and thus the intervals between the cutting portions are also large. This facilitates removing chips from between the saw chain and an object to be cut. Thus, the accumulation of chips between the saw chain and the object to be cut is further suppressed during cutting work. The configuration above thus can suppress chips from accumulating between the saw chain and an object to be cut during cutting work, while suppressing the object from shaking against the saw chain.

### BRIEF DESCRIPTION OF DRAWINGS

FIG. 1 shows a saw chain 2 according to a first embodiment mounted on a chainsaw body T1 via a guide bar 4.

FIG. 2 shows an interior structure of the chainsaw body T1 in the first embodiment.

FIG. 3 shows a partial perspective view of the saw chain 2 according to the first embodiment.

FIG. 4 shows a partial and enlarged right side view of the saw chain 2 according to the first embodiment, where the saw chain 2 is mounted on the guide bar 4.

FIG. 5 shows a right side view of a cutting link 38R of the saw chain 2 according to the first embodiment.

FIG. 6 shows a partial view of the saw chain 2 according to the first embodiment viewed in a direction orthogonal to a left-right direction and a chain movement direction.

FIG. 7 shows a saw chain 2 according to a second embodiment mounted on a chainsaw body T2 via a guide bar 4.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved saw chains as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, as the cutting portion is viewed in the left-right direction, an area of a space bounded by a straight line connecting the top of the cutting blade and the top of the depth gauge and an outer edge of the cutting portion (this area of space may be referred to as “notch area” herein) may be in a range of 10 mm² to 14 mm².

In the configuration above, the notch area is small, allowing for a further reduction in the size of the cutting portions. This further suppresses an object to be cut from shaking against the saw chain during cutting work.

In one or more embodiments, for each of the at least two side links each comprising the cutting portion, a distance between the top of the cutting blade and a bottom of the side link in the chain height direction (this distance may be referred to as “blade height” herein) may be in a range of 8.0 mm to 10.0 mm.

A larger blade height means that there is a larger difference between the height of the side links comprising the cutting portions (the width thereof in the chain height direction) and the height of the side links without the cutting portions, and thus a larger blade height leads to a larger gap formed between the saw chain and an object to be cut during cutting work. In the configuration above, the blade height is moderately large, and thus a moderately large gap can be formed between the saw chain and an object to be cut during cutting work. This facilitates removing chips from between the saw chain and the object to be cut. Thus, the configuration above can further suppress the accumulation of chips between the saw chain and the object to be cut during cutting work.

In one or more embodiments, on the left side and the right side of the plurality of drive links, side links each comprising the cutting portion (these side links may be referred to as “cutting links” herein) and side links that do not comprise the cutting portion (these side links may be referred to as “tie straps”) may be alternately arranged along the chain movement direction.

Saw chains are classified into multiple types depending on the arrangement of cutting links and tie straps. In the configuration above, the saw chain is of a type having the highest rate of cutting links relative to all the side links (so-called full house chain). The saw chain of this type can provide an increased amount of cutting per travel distance of the saw chain (e.g., as the saw chain rotates once about the guide bar) and thus improves work efficiency.

In one or more embodiments, the saw chain may be configured to be mounted on a chainsaw body of top handle type. The chainsaw body may comprise a prime mover configured to drive the saw chain, a housing supporting the guide bar and the prime mover, and a top handle that is located vertically above the housing when the housing is placed on a horizontal plane.

There are mainly three types of chainsaw bodies, namely rear handle type, top handle type, and compact type. Chainsaw bodies of rear handle type are used for high-load work (e.g., felling trees), while chainsaw bodies of top handle type (or compact type) are mainly used for low-load work (e.g., cutting lumbers, pruning branches, etc.). Thus, the chainsaw bodies of top handle type (or compact type) are expected to be used more often to cut an object that is not securely held in place (e.g., twig) than the chainsaw bodies of rear handle type. In the configuration above, the saw chain is mounted on the chainsaw body of top handle type when used. That is, the saw chain is expected to be frequently used to cut an object that is not securely held in place (e.g., twig). Such objects that are not securely held in place are likely to shake against the saw chain when cut. Thus, the effect of suppressing an object to be cut from shaking against the saw chain during cutting work can be significantly produced in the configuration above.

In one or more embodiments, the saw chain may be configured to be mounted on a chainsaw body of compact type. The chainsaw body may comprise a prime mover configured to drive the saw chain, a housing supporting the guide bar and the prime mover, and a grip extending from an outer surface of the housing.

There are mainly three types of chainsaw bodies, namely rear handle type, top handle type, and compact type. Chainsaw bodies of rear handle type are used for high-load work (e.g., felling trees), while chainsaw bodies of compact type (or top handle type) are mainly used for low-load work (e.g., cutting lumbers, pruning branches, etc.). Thus, the chainsaw bodies of compact type (or top handle type) are expected to be used more often to cut an object that is not securely held in place (e.g., twig) than the chainsaw bodies of rear handle type. In the configuration above, the saw chain is mounted on the chainsaw body of compact type when used. That is, the saw chain is expected to be often used to cut an object that is not securely held in place (e.g., twig). Such objects that are not securely held in place are likely to shake against the saw chain when cut. Thus, the effect of suppressing an object to be cut from shaking against the saw chain during work can be significantly produced in the configuration above.

In one or more embodiments, the saw chain may be configured to be mounted on a chainsaw body. The chainsaw body may comprise a prime mover configured to drive the saw chain and a housing supporting the guide bar and the prime mover. A weight of the chainsaw body may be in a range of 0.8 kg to 3.5 kg.

Generally, heavier chainsaw bodies are highly likely to be used for high-load work (e.g., felling trees). By contrast, lighter chainsaw bodies are highly likely to be used for low-load work (e.g., cutting lumbers, pruning branches, etc.). In the configuration above, the saw chain is mounted on the relatively light chainsaw body when used. Thus, the saw chain is expected to be often used to cut an object that is not securely held in place (e.g., twigs). Such objects that are not securely held in place are likely to shake against the saw chain when cut. Thus, the effect of suppressing an object to be cut from shaking against the saw chain during cutting work can be significantly produced in the configuration above.

### First Embodiment

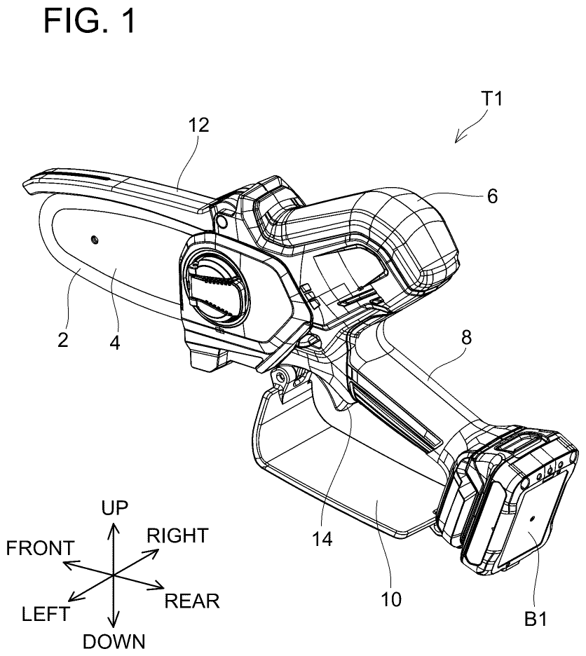

As shown in FIG. 1, a saw chain 2 according to an embodiment is mounted on a chainsaw body T1 of compact type when used. The chainsaw body T1 comprises a housing 6 supporting a guide bar 4, a grip 8 extending to protrude from an outer surface of the housing 6, a hand guard 10 configured to protect a user's hand gripping the grip 8, and a chain cover 12 partially covering the saw chain 2. A battery pack B1 can be detachably attached to an end portion of the grip 8. The battery pack B1 houses rechargeable secondary batteries, such as lithium-ion batteries, therein. The chainsaw body T1 operates with electric power supplied from the battery pack B1. A trigger lever 14 is located on the grip 8. The trigger lever 14 is positioned such that the user gripping the grip 8 can manipulate it with the index finger. In response to the trigger lever 14 being manipulated, the chainsaw body T1 moves the saw chain 2 along the periphery of the guide bar 4.

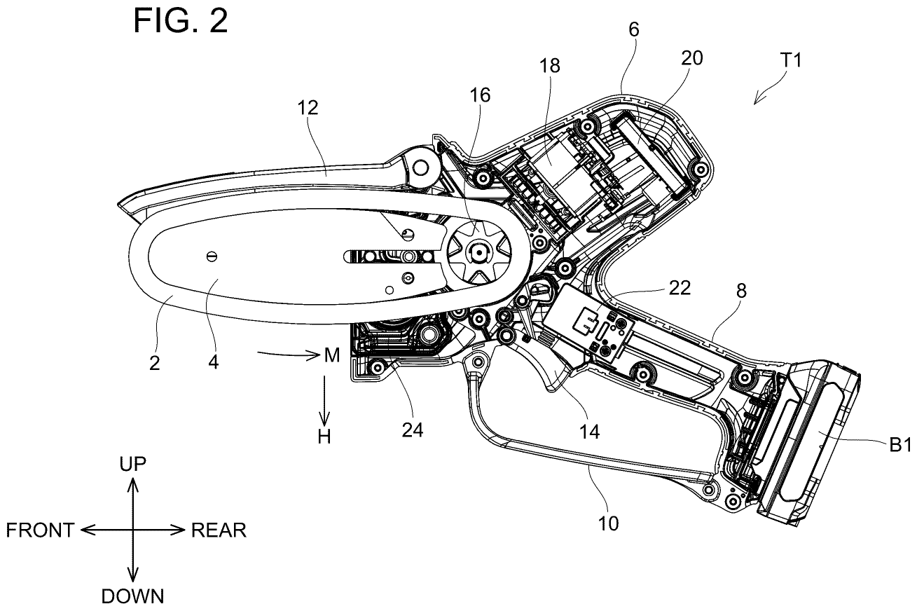

As shown in FIG. 2, the chainsaw body T1 further comprises a sprocket 16 on which the saw chain 2 is hanged from the guide bar 4, an electric motor 18 configured to drive the saw chain 2 via the sprocket 16, a control device 20 configured to control the electric motor 18, a microswitch 22 configured to detect manipulation on the trigger lever 14, an oil tank 24 storing a lubricant for lubricating the saw chain 2, and an oil pump (not shown) configured to suction the lubricant from the oil tank 24 and supply it to the saw chain 2. In this embodiment, the electric motor 18 is an inner-rotor DC brushless motor comprising a stator, a rotor disposed inward of the stator, and an output shaft fixed to the rotor. The output shaft is coupled to the sprocket 16 and the oil pump via a power transmission mechanism (e.g., bevel gear) which is not shown. The control device 20 activates the electric motor 18 in response to the microswitch 22 being pressed by the trigger lever 14 being manipulated. Once the electric motor 18 is activated, the sprocket 16 rotates to move the saw chain 2 along the periphery of the guide bar 4. Further, once the electric motor 18 is activated, the oil pump is driven and the lubricant in the oil tank 24 is supplied to the saw chain 2.

The weight of the chainsaw body T1 is, for example, in a range of 0.8 kg to 2.2 kg, and it is 1.2 kg in this embodiment. The weight of the chainsaw body T1 herein means its weight measured when the oil tank 24 is empty, the battery pack B1 is not attached to the end portion of the grip 8, and the saw chain 2 and the guide bar 4 are removed from the housing 6.

In this embodiment, regarding the longitudinal direction of the guide bar 4, a direction from the housing 6 toward the guide bar 4 is defined as a front direction, while a direction from the guide bar 4 toward the housing 6 is defined as a rear direction. Further, regarding a direction orthogonal to the guide bar 4, a direction from the oil tank 24 toward the guide bar 4 is defined as a left direction, while a direction from the guide bar 4 toward the oil tank 24 is defined as a right direction. Moreover, regarding a direction orthogonal to the front-rear direction and the left-right direction, a direction from the guide bar 4 toward the chain cover 12 is defined as an up direction, while a direction from the chain cover 12 toward the guide bar 4 is defined as a down direction.

The chainsaw body T1 moves the saw chain 2 in a predetermined direction along the periphery of the guide bar 4, for example, at a speed of 8 m/s. In this embodiment, the direction in which the saw chain 2 moves relative to the guide bar 4 is defined as a chain movement direction M. For example, the chain movement direction M is the counterclockwise direction in a left side view. Further, in this embodiment, a direction that is orthogonal to the left-right direction (i.e., a direction orthogonal to the guide bar 4) and the chain movement direction M and is away from the guide bar 4 is defined as a chain height direction H.

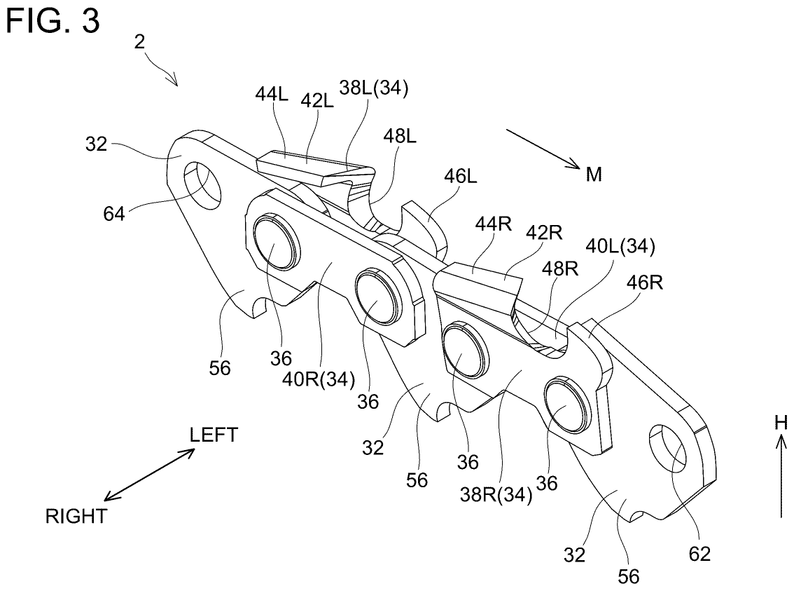

As shown in FIG. 3, the saw chain 2 comprises a plurality of drive links 32 arranged along the chain movement direction M, a plurality of side links 34 arranged on left and right sides of the plurality of drive links 32, and a plurality of connection pins 36 connecting the drive links 32 and the side links 34 to each other.

The plurality of side links 34 comprises a plurality of cutting links 38L, 38R and a plurality of tie straps 40L, 40R. The plurality of cutting links 38L and the plurality of tie straps 40L are located on the left side of the plurality of drive links 32. The plurality of cutting links 38R and the plurality of tie straps 40R are located on the right side of the plurality of drive links 32. The cutting links 38L, 38R are different from the tie straps 40L, 40R in that the cutting links 38L, 38R comprise cutting portions 42L, 42R, respectively. The cutting portions 42L, 42R comprise cutting blades 44L, 44R, depth gauges 46L, 46R located in the chain movement direction M from the cutting blades 44L, 44R, and notches 48L, 48R formed between the cutting blades 44L, 44R and the depth gauges 46L, 46R in the chain movement direction M, respectively.

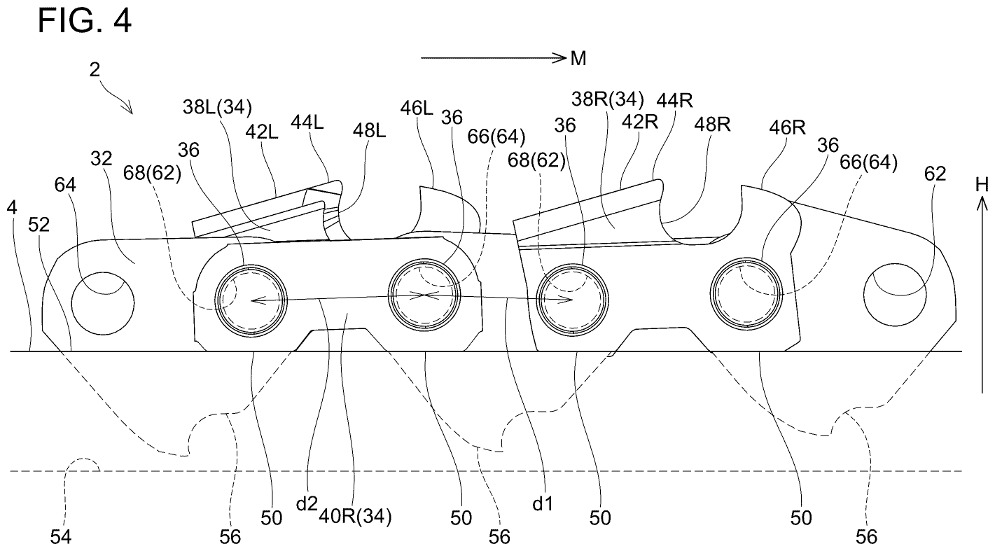

As shown in FIG. 4, the periphery of the guide bar 4 comprises a guide surface 52 that contacts bottom surfaces 50 of the side links 34 to support the saw chain 2 and a guide groove 54 recessed from the guide surface 52. Chain gauges 56 of the drive links 32 are inserted in the guide groove 54. The chain movement direction M can be construed as a direction of tangent to the guide surface 52. In FIG. 4, the guide surface 52 of the guide bar 4 is shown as being substantially a planar surface and the chain movement direction M is shown as being substantially a linear direction. The chain movement direction M is also shown as being substantially a linear direction in FIGS. 3, 5, and 6 as well.

Each drive link 32 comprises a first drive link through hole 62 and a second drive link through hole 64 located in the opposite direction to the chain movement direction M from the first drive link through hole 62. The first drive link through hole 62 and the second drive link through hole 64 both extend through the drive link 32 in the left-right direction. Each side link 34 comprises a first side link through hole 66 and a second side link through hole 68 located in the opposite direction to the chain movement direction M from the first side link through hole 66. The first side link through hole 66 and the second side link through hole 68 both extend through the side link 34 in the left-right direction. Each of the first drive link through holes 62 of the drive links 32 is connected to corresponding one of the second side link through holes 68 of the side links 34 with a connection pin 36 such that the through holes are rotatable relative to each other. Each of the second drive link through holes 64 of the drive links 32 is connected to corresponding one of the first side link through holes 66 of the side links 34 with a connection pin 36 such that the through holes are rotatable to each other.

### Chain Pitch in Saw Chain 2

In each drive link 32, the distance between the center of the first drive link through hole 62 and the center of the second drive link through hole 64 is defined as a distance d1, and in each side link 34, the distance between the center of the first side link through hole 66 and the second side link through hole 68 is defined as a distance d2. An average (d1+d2)/2 of the distance d1 and the distance d2 may be referred to as “chain pitch”. The chain pitch is, for example, in a range of 8.0 mm to 8.5 mm, and in this embodiment, it is 8.3 mm.

### Blade Height of Saw Chain 2

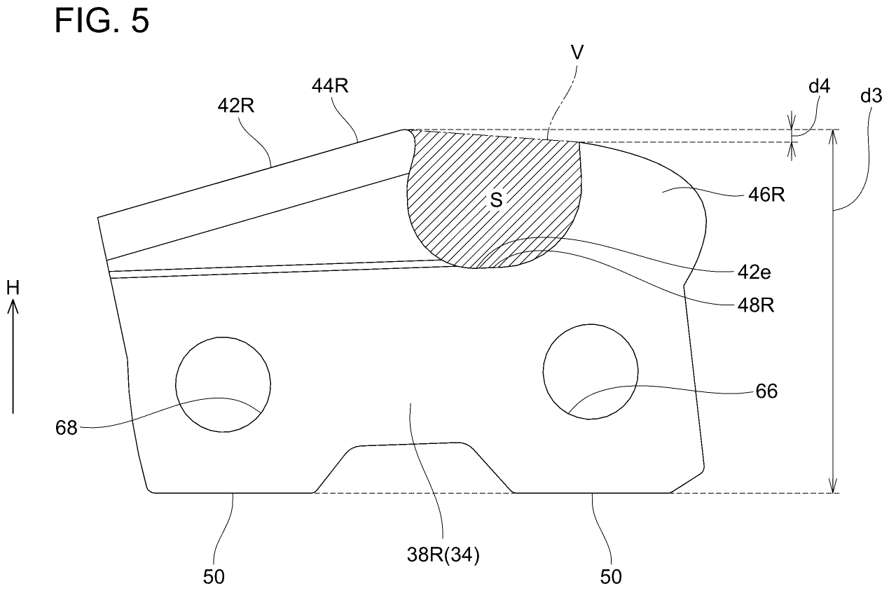

As shown in FIG. 5, a distance d3 from the bottom (i.e., the bottom surface 50) of each cutting link 38R to the top of the cutting blade 44R in the chain height direction H may be referred to as “blade height”. The blade height is, for example, in a range of 8.0 mm to 10.0 mm, and in this embodiment, it is 9.0 mm.

### Depth of Saw Chain 2

A distance d4 between the top of the cutting blade 44R and the top of the depth gauge 46R in the chain height direction H may be referred to as “depth”. The depth is, for example, in a range of 0.1 mm to 0.3 mm, and in this embodiment, it is 0.25 mm.

### Notch Area of Saw Chain 2

In a side view of a cutting portion 42R in the left-right direction, an area S of a space defined by a straight line V connecting the top of the cutting blade 44R to the top of the depth gauge 46R and an outer edge 42e of the cutting portion 42R may be referred to as “notch area”. The notch area can be construed as a value indicative of the size of the notch 48R. The notch area is, for example, in a range of 10 mm² to 14 mm², and in this embodiment, it is 12 mm².

The cutting links 38R are mirror symmetry to the cutting links 38L (see FIG. 4). Thus, the dimensions d3 (blade height), d4 (depth), and S (notch area) described referring to FIG. 5 are also applicable to the cutting links 38L.

### Kerf Width of Saw Chain 2

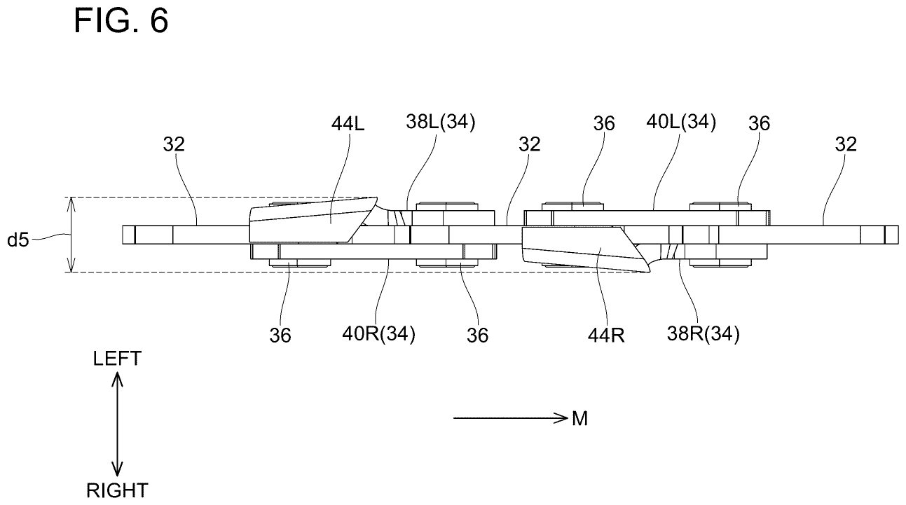

As shown in FIG. 6, a distance d5 between the left ends of the cutting blades 44L and the right ends of the cutting blades 44R in the left-right direction mat be referred to as “kerf width”. The kerf width is, for example, in a range of 4.3 mm to 4.6 mm, and in this embodiment, it is 4.5 mm.

### Arrangement of Cutting Links 38L, 38R and Tie Straps 40L, 40R

As shown in FIG. 3, the saw chain 2 is a so-called full house chain in which the cutting links 38L and the tie straps 40L are arranged alternately in the chain movement direction M on the left side of the plurality of drive links 32, and the cutting links 38R and the tie straps 40R are arranged alternately in the chain movement direction M on the right side of the plurality of drive links 32.

### Second Embodiment

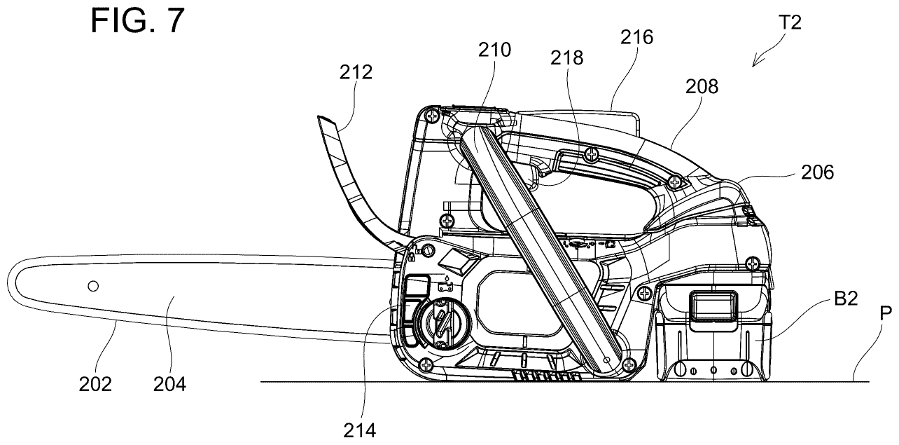

As shown in FIG. 7, a saw chain 202 according to this embodiment is mounted on a chainsaw body T2 of top handle type when used. The chainsaw body T2 comprises a housing 206 supporting a guide bar 204, a top handle 208, a side handle 210, a hand guard 212 configured to protect user's hand(s) gripping the top handle 208 and/or the side handle 210, an oil tank 214 storing a lubricant for lubricating the saw chain 202, and an electric motor (not shown) configured to drive the saw chain 202. A battery pack B2 is detachably attached to a bottom portion of the housing 206. The battery pack B2 houses rechargeable secondary batteries, such as lithium-ion batteries, therein. The chainsaw body T2 operates with electric power supplied from the battery pack B2.

When the chainsaw body T2 is on a horizontal plane P, the top handle 208 is located vertically above the housing 206. A lock-off lever 216 and a trigger lever 218 are located on the top handle 208. The trigger lever 218 is prohibited from being manipulated when the lock-off lever 216 is not manipulated. The trigger lever 218 is permitted to be manipulated when the lock-off lever 216 is manipulated. When the chainsaw body T2 is on the horizontal plane P, the side handle 210 is located on a side of the housing 206. For example, the user may grip the top handle 208 with the right hand and grip the side handle 210 with the left hand to hold the chainsaw body T2. By the user pushing down the lock-off lever 216 on the top handle 208 with the right palm, the trigger lever 218 transitions to the state of being able to be manipulated. Then, in response to the user pushing up the trigger lever 218 with the right index finger, the electric motor (not shown) start operating with electric power supplied from the battery pack B2 and thus the saw chain 202 moves along the periphery of the guide bar 204. The chainsaw body T2 moves the saw chain 202 in a predetermined direction along the periphery of the guide bar, for example, at a speed of 24 m/s.

The weight of the chainsaw body T2 is, for example, in a range of 2.0 kg to 3.5 kg, and in this embodiment, it is 2.5 kg. The weight of chainsaw body T2 herein means the weight of the chainsaw body T2 in which the oil tank 214 is empty, the battery pack B2 is not attached to the housing 206, and the saw chain 202 and the guide bar 204 are removed from the housing 206.

The saw chain 202 corresponds to the saw chain 2 according to the first embodiment with more drive links 32 connected to each other, more side links 34, and more connection pins 36. Thus, reference should be made to the first embodiment for details of the saw chain 202.

### Variants

(See FIG. 5.) In a side view of a cutting portion 42L, 42R in the left-right direction, the area S of space defined by the straight line V connecting the top of the cutting blade 44L, 44R to the top of the depth gauge 46L, 46R and the outer edge 42e of the cutting portion 42L, 42R (notch area) may be smaller than 10 mm² or larger than 14 mm².

(See FIG. 5.) The distance d3 from the bottom of the cutting link 38R to the top of the cutting blade 44R in the chain height direction H (blade height) may be smaller than 8.0 mm or larger than 10.0 mm.

(See FIG. 3.) The saw chain 2, 202 may be of another type than the full house type. For example, for combinations of side links 34 facing each other with the plurality of drive links 32 interposed therebetween, the saw chain 2, 202 may be a saw chain of standard type in which a first combination including a cutting link 38L and a tie strap 40R, a second combination including a tie strap 40L and a tie strap 40R, a third combination including a tie strap 40L and a cutting link 38R, and a fourth combination including a tie strap 40L and a tie strap 40R are arranged repeatedly in this order along the chain movement direction M.

The saw chain 2, 202 may be mounted on a chainsaw body of another type than the compact type (or the top handle type). For example, the saw chain 2, 202 may be mounted on a so-called chainsaw body of rear handle type in which a handle is located at a position of the housing that is opposite to the position of the housing where the guide bar is attached.

The saw chain 2, 202 may be mounted on a chainsaw body having the weight of less than 0.8 kg. Alternatively, the saw chain 2, 202 may be mounted on a chainsaw body having the weight of more than 3.5 kg.

### Features of Embodiments

In one or more embodiments, the saw chain 2 (the saw chain 202) is configured to be movably mounted along the periphery of the guide bar 4 (the guide bar 204). The saw chain 2 (the saw chain 202) comprises the plurality of drive links 32 each comprising two drive link through holes 62, 64, wherein the drive links 32 are arranged along the chain movement direction M in which the saw chain 2 (the saw chain 202) moves with respect to the guide bar 4 (the guide bar 204), the plurality of side links 34 each comprising two side link through holes 66, 68, wherein the side links 34 are located on both the left side and the right side of the plurality of drive links 32 in the left-right direction orthogonal to the guide bar 4 (the guide bar 204), and the plurality of connection pins 36, wherein the connection pins 36 connect the drive links 32 and the side links 34 to each other by being inserted through the drive link through holes 62, 64 and the side link through holes 66, 68. The cutting links 38L, 38R (an example of at least two side links) of the plurality of side links 34 comprise cutting portions 42L, 42R including the cutting blades 44L, 44R and the depth gauges 46L, 46R, respectively. In the left-right direction, the distance d5 (kerf width) between the left ends of the cutting blades 44L of the cutting links 38L located on the left side of the plurality of drive links 32 and the right ends of the cutting blades 44R of the cutting links 38R located on the right side of the plurality of drive links 32 is in a range of 4.3 mm to 4.6 mm. In the chain height direction H orthogonal to the left-right direction and the chain movement direction M, the distance d4 (depth) between the tops of the cutting blades 44L, 44R and the tops of the depth gauges 46L, 46R is in a range of 0.1 mm to 0.3 mm. The average (d1+d2)/2 (chain pitch) of the distance d1 between the center axes of the two drive link through holes 62, 64 of each drive link 32 and the distance d2 between the center axes of the two side link through holes 66, 68 of each side link 34 is in a range of 8.0 mm to 8.5 mm.

In the configuration above, the kerf width and the depth are both small, allowing for a reduction in the size of the cutting portions 42L, 42R. This suppresses an object to be cut from shaking against the saw chain 2 (the saw chain 202) during cutting work. Further, in the configuration above, the kerf width and the depth are both small, and thus an amount of cutting by each of the cutting portions 42L, 42R (i.e., an amount of chips generated by each of the cutting portion 42L, 42R) is reduced. This suppresses accumulation of chips between the saw chain 2 (the saw chain 202) and an object to be cut during cutting work. Moreover, in the configuration above, the chain pitch is larger than, for example, the chain pitch (approximately 6.4 mm) of a saw chain described in US Patent Application Publication No. 2011/0179652. This means that the intervals between the side links 34 in the chain movement direction M of the saw chain 2 (the saw chain 202) are relatively large and thus the intervals between the cutting portions 42L, 42R are also large. This facilitates removing chips from between the saw chain 2 (the saw chain 202) and an object to be cut. Thus, the accumulation of chips between the saw chain 2 (the saw chain 202) and the object to be cut is further suppressed during cutting work. The configuration above thus can suppress chips from accumulating between the saw chain 2 (the saw chain 202) and an object to be cut during cutting work, while suppressing the object from shaking against the saw chain 2 (the saw chain 202).

In one or more embodiments, as the cutting portion 42L (42R) is viewed in the left-right direction, the area S of space (notch area) defined by the straight line V connecting the top of the cutting blade 44L (44R) and the top of the depth gauge 46L (46R) and the outer edge 42e of the cutting portion 42L (42R) is in a range of 10 mm² to 14 mm².

In the configuration above, the notch area is small, allowing for a further reduction in the size of the cutting portions 42L, 42R. This further suppresses an object to be cut from shaking against the saw chain 2 (the saw chain 202) during cutting work.

In one or more embodiments, for the cutting links 38L, 38R (an example of the at least two side links each comprising the cutting portion), the distance d3 (blade height) between the tops of the cutting blades 44L, 44R and the bottom of the side links 34 in the chain height direction His in a range of 8.0 mm to 10.0 mm.

A larger blade height means that there is a larger difference between the height of the cutting links 38L, 38R (the width thereof in the chain height direction H) and the height of the tie straps 40L, 40R (an example of the side links without the cutting portions), and thus a larger blade height leads to a larger gap formed between the saw chain 2 (the saw chain 202) and an object to be cut during cutting work. In the configuration above, the blade height is moderately large, and thus a moderately large gap can be formed between the saw chain 2 (the saw chain 202) and an object to be cut during cutting work. This facilitates removing chips from between the saw chain 2 (the saw chain 202) and the object to be cut. Thus, the configuration above can further suppress the accumulation of chips between the saw chain 2 (the saw chain 202) and the object to be cut during cutting work.

In one or more embodiments, on the left side and the right side of the plurality of drive links 32, the cutting links 38L, 38R and the tie straps 40L, 40R are alternately arranged along the chain movement direction M.

Saw chains are classified into multiple types depending on the arrangement of cutting links and tie straps. In the configuration above, the saw chain 2 (the saw chain 202) is of a type having the highest rate of cutting links 38L, 38R relative to all the side links 34 (so-called full house chain). The saw chain 2 (the saw chain 202) of this type can provide an increased amount of cutting per travel distance of the saw chain 2 (the saw chain 202) (e.g., as the saw chain 2 (the saw chain 202) rotates once about the guide bar 4 (the guide bar 204)) and thus improves work efficiency.

In one or more embodiments, the saw chain 202 is configured to be mounted on the chainsaw body T2 of top handle type. The chainsaw body T2 comprises the electric motor (an example of prime mover) configured to drive the saw chain 202, the housing 206 supporting the guide bar 204 and the electric motor, and the top handle 208 that is located vertically above the housing 206 when the housing 206 is placed on the horizontal plane P.

There are mainly three types of chainsaw bodies, namely rear handle type, top handle type, and compact type (which may also be termed mini type or pruning type). Chainsaw bodies of rear handle type are used for high-load work (e.g., felling trees), while chainsaw bodies of top handle type (or compact type) are mainly used for low-load work (e.g., cutting lumbers, pruning branches, etc.). Thus, the chainsaw bodies of top handle type (or compact type) are expected to be used more often to cut an object that is not securely held in place (e.g., twig) than the chainsaw bodies of rear handle type. In the configuration above, the saw chain 202 is mounted on the chainsaw body T2 of top handle type when used. That is, the saw chain 202 is expected to be frequently used to cut an object that is not securely held in place (e.g., twig). Such objects that are not securely held in place are likely to shake against the saw chain 202 when cut. Thus, the effect of suppressing an object to be cut from shaking against the saw chain 202 during cutting work can be significantly produced in the configuration above.

In one or more embodiments, the saw chain 2 is configured to be mounted on the chainsaw body T1 of compact type. The chainsaw body T1 comprises the electric motor (an example of prime mover) configured to drive the saw chain 2, the housing 6 supporting the guide bar 4 and the electric motor, and the grip 8 extending from the outer surface of the housing 6.

There are mainly three types of chainsaw bodies, namely rear handle type, top handle type, and compact type. Chainsaw bodies of rear handle type are used for high-load work (e.g., felling trees), while chainsaw bodies of compact type (or top handle type) are mainly used for low-load work (e.g., cutting lumbers, pruning branches, etc.). Thus, the chainsaw bodies of compact type (or top handle type) are expected to be used more often to cut an object that is not securely held in place (e.g., twig) than the chainsaw bodies of rear handle type. In the configuration above, the saw chain 2 is mounted on the chainsaw body T1 of compact type when used. That is, the saw chain 2 is expected to be often used to cut an object that is not securely held in place (e.g., twig). Such objects that are not securely held in place are likely to shake against the saw chain 2 when cut. Thus, the effect of suppressing an object to be cut from shaking against the saw chain 2 during cutting work can be significantly produced in the configuration above.

In one or more embodiments, the saw chain 2 (the saw chain 202) is configured to be mounted on the chainsaw body T1 (the chainsaw body T2). The chainsaw body T1 (the chainsaw body T2) comprises the electric motor (an example of prime mover) configured to drive the saw chain 2 (the saw chain 202) and the housing 6 (the housing 206) supporting the guide bar 4 (the guide bar 204) and the electric motor. The weight of the chainsaw body T1 (the chainsaw body T2) is in a range of 0.8 kg to 3.5 kg.

Generally, heavier chainsaw bodies are highly likely to be used for high-load work (e.g., felling trees). By contrast, lighter chainsaw bodies are highly likely to be used for low-load work (e.g., cutting lumbers, pruning branches, etc.). In the configuration above, the saw chain 2 (the saw chain 202) is mounted on the relatively light chainsaw body T1 (chainsaw body T2) when used. Thus, the saw chain 2 (the saw chain 202) is expected to be often used to cut an object that is not securely held in place (e.g., twigs). Such objects that are not securely held in place are likely to shake against the saw chain 2 (the saw chain 202) when cut. Thus, the effect of suppressing an object to be cut from shaking against the saw chain 2 (the saw chain 202) during cutting work can be significantly produced in the configuration above.

What is claimed is:

1. A saw chain configured to be movably mounted along a periphery of a guide bar, the saw chain comprising:
a plurality of drive links each comprising two drive link through holes, wherein the drive links are arranged along a chain movement direction in which the saw chain moves with respect to the guide bar;
a plurality of side links each comprising two side link through holes, wherein the side links are located on both left side and right side of the plurality of drive links in a left-right direction orthogonal to the guide bar; and
a plurality of connection pins, wherein the connection pins connect the drive links and the side links to each other by being inserted through the drive link through holes and the side link through holes,
wherein
at least two side links of the plurality of side links each comprise a cutting portion including a cutting blade and a depth gauge,
in the left-right direction, a distance between a left end of the cutting blade of a side link of the at least two side links located on the left side of the plurality of drive links and a right end of the cutting blade of a side link of the at least two side links located on the right side of the plurality of drive links is in a range of 4.3 mm to 4.6 mm,
in a chain height direction orthogonal to the left-right direction and the chain movement direction, a distance between a top of the cutting blade of the side link and a top of the depth gauge of the side link is in a range of 0.1 mm to 0.3 mm, and
an average of a distance between center axes of the two drive link through holes of each drive link and a distance between center axes of the two side link through holes of each side link is in a range of 8.0 mm to 8.5 mm.

2. The saw chain according to claim 1, wherein
as the cutting portion is viewed in the left-right direction, an area of a space defined by a straight line connecting the top of the cutting blade and the top of the depth gauge and an outer edge of the cutting portion is in a range of 10 mm² to 14 mm².

3. The saw chain according to claim 1, wherein
for each of the at least two side links each comprising the cutting portion, a distance between the top of the cutting blade and a bottom of the side link in the chain height direction is in a range of 8.0 mm to 10.0 mm.

4. The saw chain according to claim 1, wherein
on the left side and the right side of the plurality of drive links, side links each comprising the cutting portion and side links that do not comprise the cutting portion are alternately arranged along the chain movement direction.

5. The saw chain according to claim 1, wherein
the saw chain is configured to be mounted on a chainsaw body of top handle type, and
the chainsaw body comprises:
a prime mover configured to drive the saw chain;
a housing supporting the guide bar and the prime mover; and
a top handle that is located vertically above the housing when the housing is placed on a horizontal plane.

6. The saw chain according to claim 1, wherein
the saw chain is configured to be mounted on a chainsaw body of compact type, and
the chainsaw body comprises:
a prime mover configured to drive the saw chain;
a housing supporting the guide bar and the prime mover; and
a grip extending from an outer surface of the housing.

7. The saw chain according to claim 1, wherein
the saw chain is configured to be mounted on a chainsaw body, and
the chainsaw body comprises:
a prime mover configured to drive the saw chain; and
a housing supporting the guide bar and the prime mover, and
a weight of the chainsaw body is in a range of 0.8 kg to 3.5 kg.

8. The saw chain according to claim 2, wherein
for each of the at least two side links each comprising the cutting portion, a distance between the top of the cutting blade and a bottom of the side link in the chain height direction is in a range of 8.0 mm to 10.0 mm,
on the left side and the right side of the plurality of drive links, side links each comprising the cutting portion and side links that do not comprise the cutting portion are alternately arranged along the chain movement direction,
the saw chain is configured to be mounted on a chainsaw body of top handle type, and
the chainsaw body comprises:
a prime mover configured to drive the saw chain;
a housing supporting the guide bar and the prime mover; and
a top handle that is located vertically above the housing when the housing is placed on a horizontal plane.

9. The saw chain according to claim 2, wherein
for each of the at least two side links each comprising the cutting portion, a distance between the top of the cutting blade and a bottom of the side link in the chain height direction is in a range of 8.0 mm to 10.0 mm,
on the left side and the right side of the plurality of drive links, side links each comprising the cutting portion and side links that do not comprise the cutting portion are alternately arranged along the chain movement direction,
the saw chain is configured to be mounted on a chainsaw body of compact type, and
the chainsaw body comprises:
a prime mover configured to drive the saw chain;
a housing supporting the guide bar and the prime mover; and
a grip extending from an outer surface of the housing.
